(19) United States
(12) Patent Application Publication
(10) Pub. No.: US 2026/0286818 A1
(43) Pub. Date: Sep. 24, 2026

(54) INTELLIGENT SYSTEM FOR DRILL-COMPLETION SIMULATION EXPERIMENTS

(71) Applicant: CHENGDU UNIVERSITY OF TECHNOLOGY, Chengdu (CN)

(72) Inventors: Qingyou Liu, Chengdu (CN); Xingming Wang, Huaying (CN); Qiaozhu Wang, Chengdu (CN); Jianguo Zhao, Chengdu (CN); Xuecheng Dong, Chengdu (CN); Li Zhang, Chengdu (CN); Xu Luo, Chengdu (CN)

(21) Appl. No.: 19/689,928

(22) Filed: May 27, 2026

(30) Foreign Application Priority Data
May 11, 2026 (CN) 202610642026.9

(51) Int. Cl. E21B 43/16

(52) U.S. Cl. CPC E21B 43/16; E21B 2200/20

(57) ABSTRACT

The present application provides an intelligent system for drill-completion simulation experiments. The system includes a base, where a gantry frame is slidably connected to a top portion of the base, a movable drilling rig system is slidably connected to the top portion of the base, a rock sample loading system and a placing rack are fixedly connected in the base, a simulated wellbore is arranged on the placing rack, and the simulated wellbore is formed by a combination of a straight wellbore structure and a deviated wellbore structure. According to the present application, a flexible movement of an overall position of a drilling rig structure is achieved through provision of a movable drilling rig system in cooperation with a variable wellbore arrangement system; and an operating height and an inclination angle of a drilling operation end are adjusted through cooperation between an angle adjustment structure and a height adjustment structure.

### CROSS-REFERENCE TO RELATED APPLICATIONS

This application claims priority to Chinese Patent Application No. 202610642026.9, filed on May 11, 2026, which is hereby incorporated by reference in its entirety.

### TECHNICAL FIELD

The present application relates to the technical field of drill-completion simulation experiments, and in particular, to an intelligent system for drill-completion simulation experiments.

### BACKGROUND

With oil and gas exploration and development gradually shifting toward deep formations, deepwater regions, and unconventional resources, deep wells, ultra-deep wells, extended reach wells, and ultra-long horizontal wells have become major well types for oil and gas development. In such complex well types, longitudinal, lateral, and torsional coupled vibrations of a drill string having a length of several thousand meters cause extremely complex dynamic characteristics of a drill bit in a downhole environment, thereby seriously affecting service life and rock-breaking efficiency of the drill bit.

At present, certain progress has been achieved in the field of intelligent drill-completion technologies domestically and internationally. Research, development, and application of equipment such as the TerrAdapt adaptive drill bit from Baker Hughes, the iCruise rotary steerable system from Halliburton, and the “Xuanji” rotary steerable system engineered by China National Offshore Oil Corporation have promoted preliminary advancement of drill-completion technologies from informatization toward automation. However, existing experimental systems generally have problems of single simulated operating conditions and low parameter regulation precision, thereby seriously restricting an industrialization process of intelligent drill-completion technologies. In view of the above, the present application provides an intelligent drill-completion simulation experimental device for a downhole robot, so as to satisfy requirements.

### SUMMARY

To solve the above technical problem, the present application is to provide an intelligent system for drill-completion simulation experiments, where a flexible movement of an overall position of a drilling rig structure can be achieved through provision of a movable drilling rig system in cooperation with a variable wellbore arrangement system; an operating height and an inclination angle of a drilling operation end can be adjusted through cooperation between an angle adjustment structure and a height adjustment structure; in cooperation with a rotatable rock sample loading cylinder and a plurality of types of simulated wellbore structures that may be spliced and combined arbitrarily, adaptation to straight and deviated wellbore trajectories can be achieved; and rock samples having different sizes and different types can also be loaded, such that a plurality of complex downhole drill-completion operating conditions can be simulated. Therefore, through the above arrangements, problems of single operating conditions, poor adaptability, and low parameter regulation precision of a conventional simulation experimental device can be solved.

To solve the above technical problem, the present application provides the following technical solutions:

An intelligent system for drill-completion simulation experiments includes a base, a gantry frame is slidably connected to a top portion of the base, a movable drilling rig system is slidably connected to the top portion of the base, a rock sample loading system and a placing rack are fixedly connected in the base, a simulated wellbore is arranged on the placing rack, and the simulated wellbore is formed by a combination of a straight wellbore structure and a deviated wellbore structure; the movable drilling rig system includes a moving platform and a support frame, the support frame is rotatably connected to a top portion of the moving platform, and a drilling rig connecting member is mounted on the support frame; the rock sample loading system includes a mounting frame and a rock sample loading cylinder, the rock sample loading cylinder is rotatably connected to a top portion of the mounting frame; and the intelligent system for drill-completion simulation experiments further includes a variable wellbore arrangement system, where the variable wellbore arrangement system is configured for arbitrary splicing and combination of multi-specification simulated wellbores, and the variable wellbore arrangement system is connected to each of the base and the simulated wellbore.

Optionally, a fixed base plate is fixedly connected to the top portion of the moving platform, the fixed base plate is rotatably hinged to two sides of a bottom of the support frame, a first hydraulic telescopic rod is rotatably connected to the top portion of the moving platform, one end of the first hydraulic telescopic rod away from the moving platform is rotatably hinged to the support frame, two second hydraulic telescopic rods are symmetrically arranged on the support frame, a telescopic end of the second hydraulic telescopic rod is fixedly connected to the drilling rig connecting member, a pneumatic clamp is fixedly connected to the top portion of the moving platform, and the pneumatic clamp is in corresponding cooperation with the drilling rig connecting member.

Optionally, a driving mechanism is fixedly connected to the top portion of the mounting frame, the driving mechanism is configured to drive the rock sample loading cylinder to rotate at the top portion of the mounting frame, and a transition wellbore is fixedly connected to a top portion of the rock sample loading cylinder.

Optionally, the variable wellbore arrangement system includes a guide rail fixedly connected in the base, a bottom pipe frame is fixedly connected to a top portion of the guide rail, a top pipe frame is correspondingly arranged at a top portion of the bottom pipe frame, and the simulated wellbore is detachably inserted and clamped between the bottom pipe frame and the top pipe frame; and the variable wellbore arrangement system further includes an outer sealing sleeve sleeved at an end portion of the simulated wellbore, an inner sealing sleeve is fixedly connected to a side of the outer sealing sleeve away from the simulated wellbore, an outer sealing ring is fixedly connected between the outer sealing sleeve and the inner sealing sleeve, and an inner sealing ring is fixedly connected to an inner wall of the outer sealing ring.

Optionally, a fixing frame is fixedly connected to one side of the guide rail, two side baffles are symmetrically arranged at the top portion of the guide rail, a spacing between the two side baffles is adapted to a bottom width of the bottom pipe frame for positioning limitation, an installation groove is formed in a middle portion of the guide rail, and the bottom pipe frame is locked and fixed in the installation groove through bolts and nuts.

Optionally, adjusting sleeves are fixedly connected to two sides of the bottom pipe frame and a top portion of the top pipe frame, a clamping plate is slidably connected in the adjusting sleeve, a first adjusting knob is in threaded connection with an end portion of the adjusting sleeve, a second adjusting knob is slidably connected to an outer side wall of the adjusting sleeve, the second adjusting knob is in threaded connection with the clamping plate, a relief sliding slot is formed in the adjusting sleeve and configured to allow sliding and positioning limitation of the second adjusting knob, and the bottom pipe frame and the top pipe frame are locked and fixed through bolts and nuts.

Optionally, an inner wall of the outer sealing sleeve is fitted to an outer wall of the simulated wellbore, and an outer wall of the inner sealing sleeve is fitted to an inner wall of the simulated wellbore.

Optionally, two sets of the outer sealing sleeve and the inner sealing sleeve are respectively configured at docking end portions of two adjacent sections of the simulated wellbore, a sealing gap is reserved between the outer sealing sleeve and the inner sealing sleeve, and two sides of the outer sealing ring are embedded and clamped in the sealing gap.

Optionally, a first hollow cavity is formed in the outer sealing ring, a second hollow cavity is formed in the inner sealing ring and conforming to a contour of the first hollow cavity, and an outer wall of the inner sealing ring is fitted to an inner wall of the inner sealing sleeve.

Optionally, a pressing plate is installed on an outer side of the outer sealing sleeve, a third adjusting knob penetrates through the pressing plate, and the third adjusting knob sequentially penetrates through the pressing plate, the outer sealing sleeve, the inner sealing sleeve, and the outer sealing ring to achieve overall compression and fixation.

Compared with the prior art, the present application at least has the following beneficial effects:

according to the above technical solution, a flexible movement of an overall position of a drilling rig structure is achieved through provision of a movable drilling rig system in cooperation with a variable wellbore arrangement system; an operating height and an inclination angle of a drilling operation end are adjusted through cooperation between an angle adjustment structure and a height adjustment structure; in cooperation with a rotatable rock sample loading cylinder and a plurality of types of simulated wellbore structures that may be spliced and combined arbitrarily, adaptation to straight and deviated wellbore trajectories can be achieved; and rock samples of different sizes and different types can be loaded, such that a plurality of complex downhole drill-completion operating conditions can be simulated, thereby effectively solving problems of single operating conditions and poor adaptability of conventional simulation experimental devices, and significantly improving general performance and experimental applicability of the device.

### BRIEF DESCRIPTION OF DRAWINGS

The accompanying drawings, which are incorporated in and constitute a part of the specification, illustrate embodiments of the present application, and further serve to explain principles of the present application together with the specification, and enable those skilled in the related art to make and use the present application.

FIG. 1 is a schematic diagram of a perspective structure of an intelligent system for drill-completion simulation experiments from a first viewing angle;

FIG. 2 is a schematic diagram of a perspective structure of an intelligent system for drill-completion simulation experiments from a second viewing angle;

FIG. 3 is a schematic diagram of a perspective structure of a movable drilling rig system from a first viewing angle;

FIG. 4 is a schematic diagram of a perspective structure of a movable drilling rig system from a second viewing angle;

FIG. 5 is a schematic diagram of a cross-sectional perspective structure of an intelligent system for drill-completion simulation experiments;

FIG. 6 is a schematic diagram of a perspective structure of a rock sample loading system;

FIG. 7 is a schematic diagram of a perspective structure of a placing rack and a simulated wellbore;

FIG. 8 is a schematic diagram of a perspective structure of a variable wellbore arrangement system from a first viewing angle;

FIG. 9 is a schematic diagram of a partial enlarged structure of FIG. 8;

FIG. 10 is a schematic diagram of a perspective structure of a bottom pipe frame and a top pipe frame from a first viewing angle;

FIG. 11 is a schematic diagram of a perspective structure of a bottom pipe frame and a top pipe frame from a second viewing angle;

FIG. 12 is a schematic diagram of a perspective structure of a simulated wellbore and an outer sealing ring;

FIG. 13 is a schematic diagram of a cross-sectional perspective structure of a simulated wellbore and an outer sealing ring;

FIG. 14 is a schematic diagram of a cross-sectional perspective structure of an outer sealing ring and an inner sealing ring;

FIG. 15 is a schematic diagram of a perspective structure of a pressing plate; and

FIG. 16 is a schematic diagram of a perspective structure of an outer sealing sleeve and an inner sealing sleeve.

### REFERENCE NUMERALS

1. base; 2. gantry frame; 3. moving platform; 4. fixed base plate; 5. support frame; 6. first hydraulic telescopic rod; 7. second hydraulic telescopic rod; 8. drilling rig connecting member; 9. pneumatic clamp; 10. mounting frame; 11. rock sample loading cylinder; 12. transition wellbore; 13. driving mechanism; 14. placing rack; 15. simulated wellbore; 16. guide rail; 17. fixing frame; 18. side baffle; 19. installation groove; 20. bottom pipe frame; 21. top pipe frame; 22. adjusting sleeve; 23. clamping plate; 24. first adjusting knob; 25. second adjusting knob; 26. outer sealing sleeve; 27. inner sealing sleeve; 28. outer sealing ring; 29. inner sealing ring; 30. first hollow cavity; 31. second hollow cavity; 32. pressing plate; 33. third adjusting knob; 34. movable drilling rig system; 35. rock sample loading system; 36. variable wellbore arrangement system; 37. relief sliding slot; 38. bolt; and 39. nut.

### DESCRIPTION OF EMBODIMENTS

An intelligent system for drill-completion simulation experiments provided by the present application is described in detail below in conjunction with the accompanying drawings and specific embodiments. Meanwhile, explanation is made herein that, to make the embodiments more detailed, the following embodiments are optimal embodiments and preferred embodiments. For some known technologies, those skilled in the art may also implement by adopting other alternative manners. In addition, the drawing part is only for more specifically describing the embodiments, and is not intended to specifically limit the present application.

It can be understood that meanings of “on”, “over”, and “above” in the present application should be interpreted in a broadest manner, so that “on” not only means “directly on” something, but also includes being on something with an intermediate feature or layer therebetween, and “over” or “above” not only means being “over” or “above” something, but also can include being “over” or “above” something without an intermediate feature or layer therebetween.

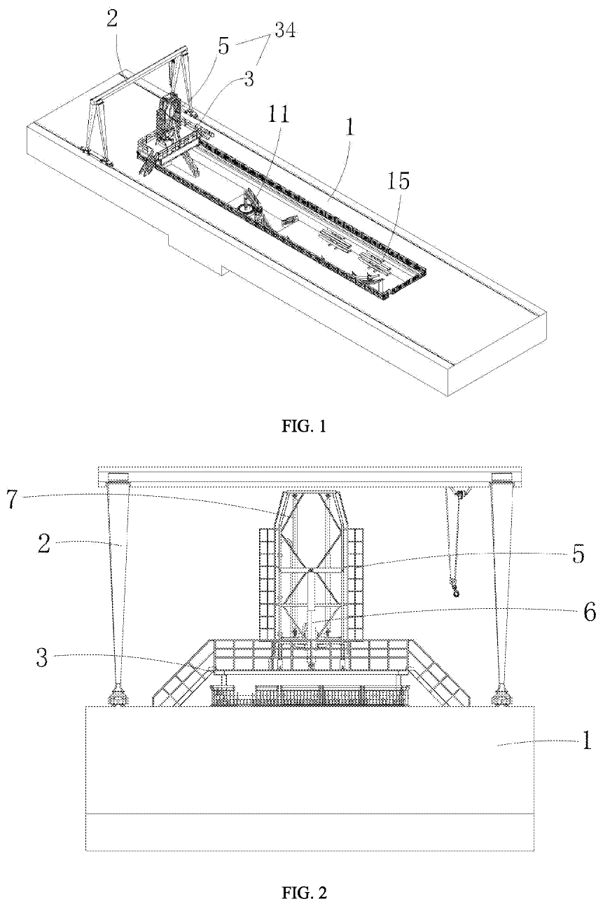

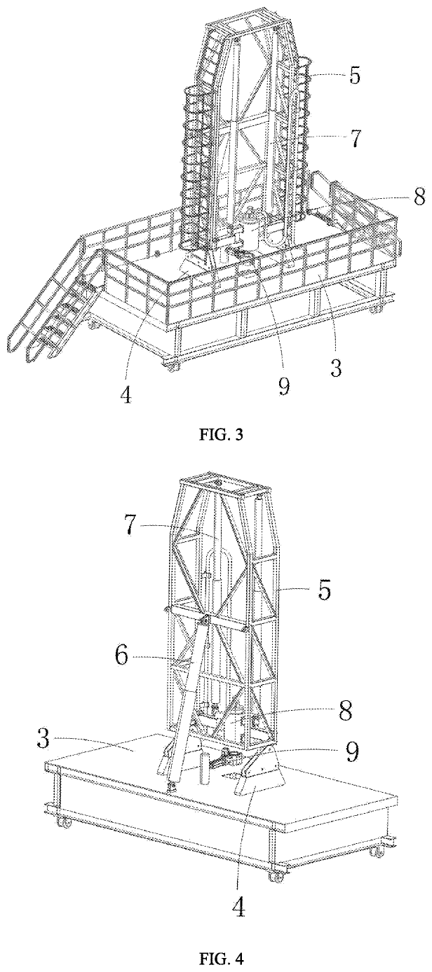

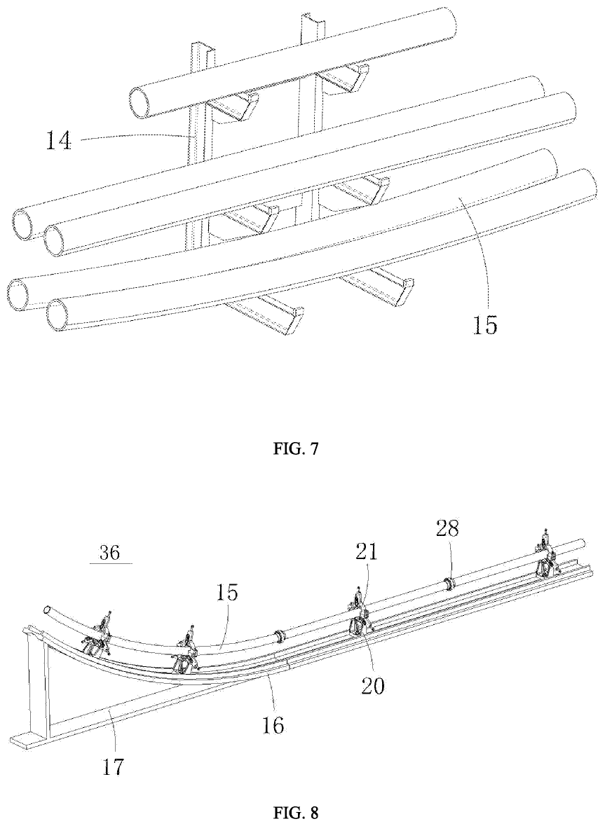

As shown in FIG. 1 to FIG. 7, an embodiment of the present application provides an intelligent system for drill-completion simulation experiments. The intelligent system for drill-completion simulation experiments includes a base 1, a gantry frame 2 is slidably connected to a top portion of the base 1, a placing rack 14 is fixedly connected in the base 1, a simulated wellbore 15 is arranged on the placing rack 14, the simulated wellbore 15 is formed by a combination of a straight wellbore structure and a deviated wellbore structure, a movable drilling rig system 34 is slidably connected to the top portion of the base 1, the movable drilling rig system 34 includes a moving platform 3 and a support frame 5, the support frame 5 is rotatably connected to a top portion of the moving platform 3, a drilling rig connecting member 8 is mounted on the support frame 5, a fixed base plate 4 is fixedly connected to the top portion of the moving platform 3, the fixed base plate 4 is rotatably hinged to two sides of a bottom portion of the support frame 5, a first hydraulic telescopic rod 6 is rotatably connected to the top portion of the moving platform 3, one end of the first hydraulic telescopic rod 6 away from the moving platform 3 is rotatably hinged to the support frame 5. two second hydraulic telescopic rods 7 are symmetrically arranged on the support frame 5, telescopic ends of the second hydraulic telescopic rods 7 are fixedly connected to the drilling rig connecting member 8, a pneumatic clamp 9 is fixedly connected to the top portion of the moving platform 3, and the pneumatic clamp 9 correspondingly cooperates with the drilling rig connecting member 8.

According to the above structure, the bottom portion of the support frame 5 is rotatably connected to the fixed base plate 4 at the top portion of the moving platform 3, a relative included angle between the support frame 5 and the moving platform 3 can be adjusted through driving of the first hydraulic telescopic rod 6, thereby achieving adjustment of a relative included angle between the drilling rig connecting member 8 and the moving platform 3. In addition, an installation height of the drilling rig connecting member 8 on the support frame 5 can be adjusted through driving of the second hydraulic telescopic rods 7, thereby adjusting a relative height between the drilling rig connecting member 8 and the moving platform 3. In summary, experimental personnel can drive the drilling rig connecting member 8 to move in position at the top portion of the base 1 through the movable drilling rig system 34, and adjust a working height and an inclination angle of the drilling rig connecting member 8 respectively through adjustment functions of the first hydraulic telescopic rod 6 and the second hydraulic telescopic rods 7 after movement to a proper experimental position, such that the movable drilling rig system 34 can adapt to different types of simulated wellbores 15 to perform simulated drilling experiments, thereby effectively improving universality and applicability of the simulation experimental system.

Optionally, the pneumatic clamp 9 can clamp and fix simulated wellbores 15 having different calibers, and adaptive matching can be performed in accordance with height adjustment and angle adjustment of the drilling rig connecting member 8, thereby avoiding displacement or shaking of the simulated wellbore 15 caused by factors such as drill string movement and high-pressure drilling fluid impact during a drilling experiment process, and effectively improving stability of an experimental process and accuracy of experimental data. In this technical solution, a specific working principle of the pneumatic clamp 9 belongs to the prior art and is not described herein again.

In this embodiment, as shown in FIG. 1 to FIG. 6, a rock sample loading system 35 is fixedly connected in the base 1, the rock sample loading system 35 includes a mounting frame 10 and a rock sample loading cylinder 11, the rock sample loading cylinder 11 is rotatably connected to a top portion of the mounting frame 10, a driving mechanism 13 is fixedly connected to the top portion of the mounting frame 10, the driving mechanism 13 is configured to drive the rock sample loading cylinder 11 to rotate at the top portion of the mounting frame 10, and a transition wellbore 12 is fixedly connected to a top portion of the rock sample loading cylinder 11.

According to the above structure, the rock sample loading cylinder 11 can freely rotate at the top portion of the mounting frame 10 to complete angle adjustment under the driving action of the driving mechanism 13, and the transition wellbore 12 is configured to achieve connection and assembly between the drilling rig connecting member 8 and the rock sample loading cylinder 11. The assembly stability between the transition wellbore 12 and the drilling rig connecting member 8 can be effectively improved under clamping and fixing action of the pneumatic clamp 9. In addition, rock samples having different sizes and different types can be loaded in the rock sample loading cylinder 11, such that the experimental device can perform simulated drilling experiments for various rock samples, and simulate a plurality of complex downhole operating conditions, thereby further improving universality and applicability of the simulation experimental system.

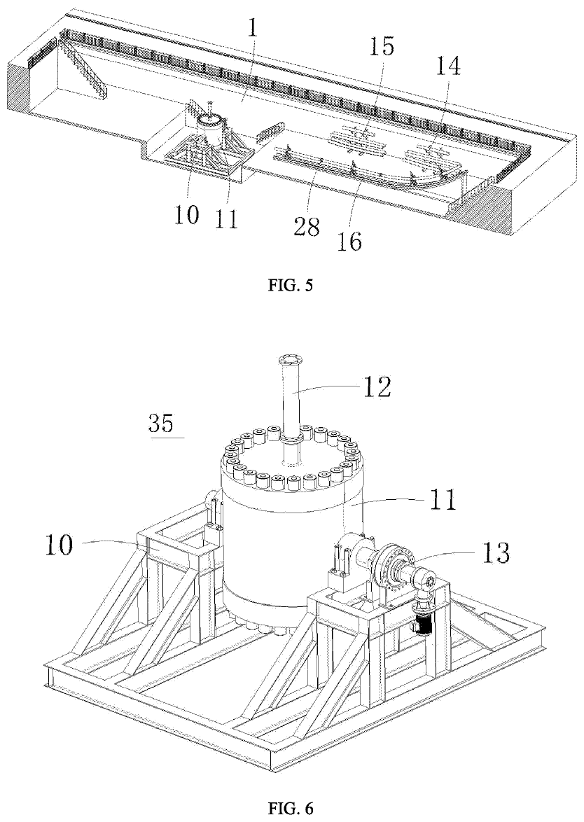

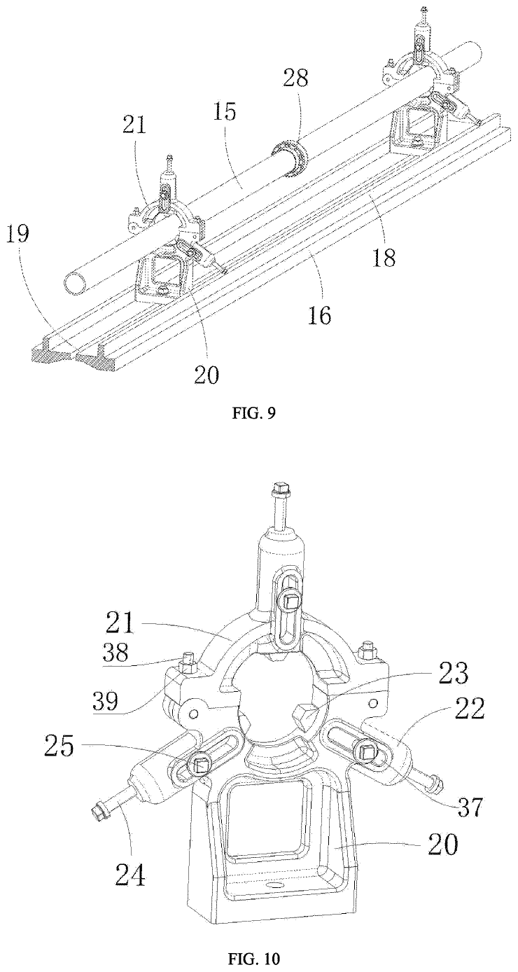

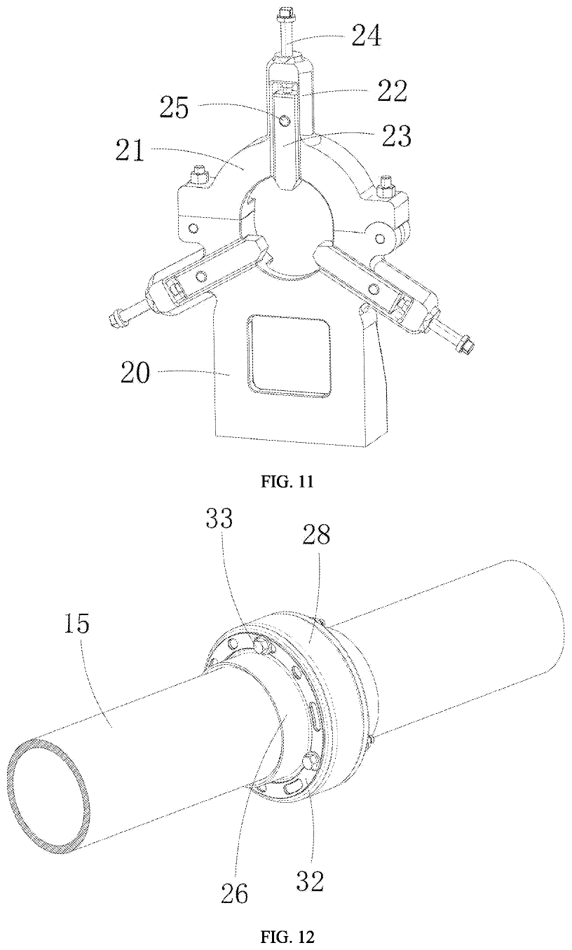

As an implementation in this embodiment, as shown in FIG. 5 to FIG. 11, the variable wellbore arrangement system 36 is configured for arbitrary splicing and combination of simulated wellbores 15 having a plurality of specifications, the variable wellbore arrangement system 36 is connected to each of the base 1 and the simulated wellbore 15, the variable wellbore arrangement system 36 includes a guide rail 16 fixedly connected in the base 1, a bottom pipe frame 20 is fixedly connected to a top portion of the guide rail 16, a top pipe frame 21 is correspondingly arranged at a top portion of the bottom pipe frame 20, and the simulated wellbore 15 is detachably inserted and clamped between the bottom pipe frame 20 and the top pipe frame 21; and a fixing frame 17 is fixedly connected to one side of the guide rail 16, two side baffles 18 are symmetrically arranged at the top portion of the guide rail 16, a spacing between the two side baffles 18 is adapted to a bottom width of the bottom pipe frame 20 for positioning limitation, an installation groove 19 is formed in a middle portion of the guide rail 16, the bottom pipe frame 20 is locked and fixed in the installation groove 19 through bolts and nuts, adjusting sleeves 22 are fixedly connected to two sides of the bottom pipe frame 20 and a top portion of the top pipe frame 21, a clamping plate 23 is slidably connected in the adjusting sleeve 22, a first adjusting knob 24 is in threaded connection with an end portion of the adjusting sleeve 22, a second adjusting knob 25 is slidably connected to an outer side wall of the adjusting sleeve 22, the second adjusting knob 25 is in threaded connection with the clamping plate 23, a relief sliding slot 37 is formed in the adjusting sleeve 22 for sliding and positioning limitation of the second adjusting knob 25, and the bottom pipe frame 20 and the top pipe frame 21 are locked and fixed through bolts 38 and nuts 39.

According to the above structure, the bottom pipe frame 20 and the top pipe frame 21 are both slidably assembled on the top portion of the guide rail 16, and two sides of the bottom portion of the bottom pipe frame 20 are subjected to blocking and positioning limitation through the side baffles 18. After assembly positions of the bottom pipe frame 20 and the top pipe frame 21 are adjusted in place, locking and fixation between the bottom pipe frame 20 and the guide rail 16 and between the top pipe frame 21 and the guide rail 16 can be achieved through bolts and nuts. Through such an arrangement, the bottom pipe frame 20 and the top pipe frame 21 can conform to a contour trend of the guide rail 16, and installation and fixation positions of the bottom pipe frame 20 and the top pipe frame 21 on the guide rail 16 can be adjusted arbitrarily.

Further, clamping plates 23 configured to clamp the simulated wellbore 15 are assembled on the bottom pipe frame 20 and the top pipe frame 21, and the clamping plates 23 are not only slidably assembled in the adjusting sleeves 22, but also can be locked and fixed through the first adjusting knobs 24 and the second adjusting knobs 25, thereby adjusting assembly positions of the clamping plates 23 relative to the bottom pipe frame 20 and the top pipe frame 21. Through the adjustable structure, the bottom pipe frame 20 and the top pipe frame 21 can adapt to simulated wellbores 15 having different sizes for clamping and fixation. After the bottom pipe frame 20 and the top pipe frame 21 are locked and fixed on the guide rail 16, stable supporting and positioning functions can be provided for the simulated wellbore 15. The experimental personnel can fix two sets of the bottom pipe frames 20 and the top pipe frames 21 on two sides of a splicing position between two adjacent sets of simulated wellbores 15, and locking and positioning limitation of two sets of abutted simulated wellbores 15 can be achieved through the two sets of the bottom pipe frames 20 and the top pipe frames 21, thereby effectively ensuring firmness and integrity of splicing assembly structures of a plurality of sections of simulated wellbores 15.

In this technical solution, an overall contour of the guide rail 16 can be custom-processed according to actual experimental requirements. A structural contour of the guide rail 16 shown in the accompanying drawings of this specification is applicable to splicing assembly of horizontal simulated wellbores 15 and deviated simulated wellbores 15. The splicing assembly manners of other types of simulated wellbores 15 are similar thereto and are not described one by one herein.

In summary, arbitrary splicing and combination of simulated wellbores 15 having a plurality of specifications and a plurality of types can be achieved through arrangement of the variable wellbore arrangement system 36. During a splicing process of the simulated wellbores 15, the bottom pipe frame 20 and the top pipe frame 21 can not only provide supporting and positioning functions for the simulated wellbores 15, but also ensure overall stability of a splicing structure of the simulated wellbores 15. Meanwhile, positions of the bottom pipe frame 20 and the top pipe frame 21 can be freely adjusted in a sliding manner according to the contour of the guide rail 16, thereby adapting to splicing assembly requirements of different types of simulated wellbores 15 and ensuring stability after structural splicing of various simulated wellbores 15. Therefore, the experimental device can match different types of simulated wellbores 15 to complete simulated drilling experiments under a plurality of downhole operating conditions, thereby greatly improving experimental adaptability and application range of the device.

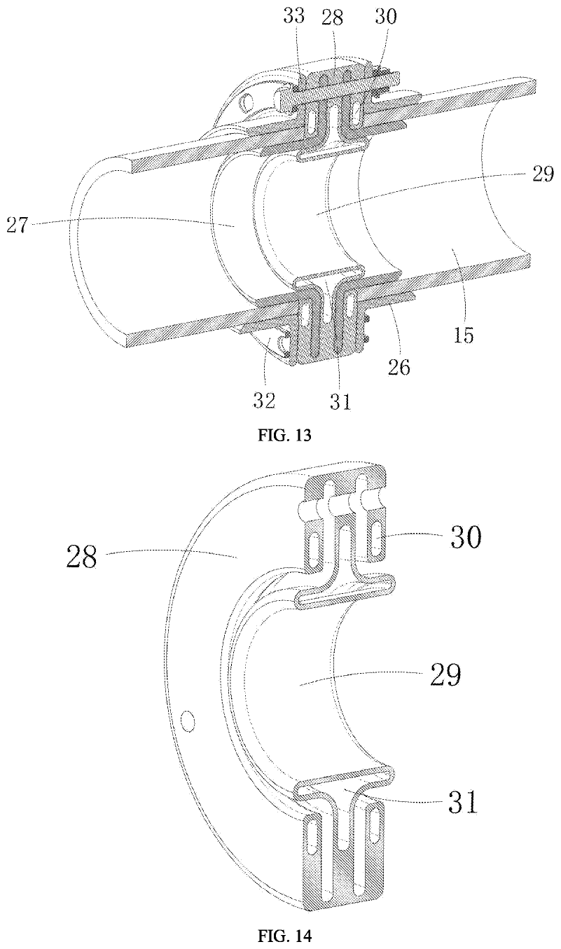

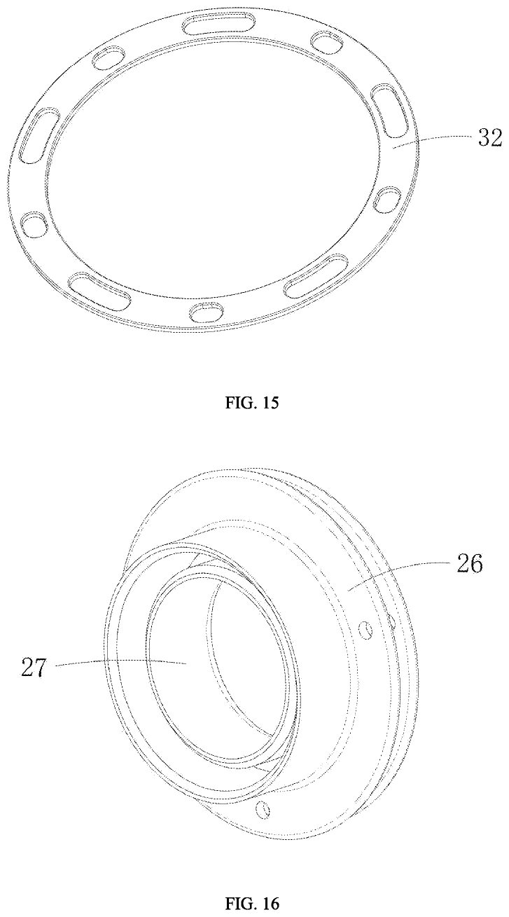

In this embodiment, as shown in FIG. 5 to FIG. 16, the variable wellbore arrangement system 36 further includes an outer sealing sleeve 26 sleeved at an end portion of the simulated wellbore 15, an inner sealing sleeve 27 is fixedly connected to one side of the outer sealing sleeve 26 away from the simulated wellbore 15, an outer sealing ring 28 is fixedly connected between the outer sealing sleeve 26 and the inner sealing sleeve 27, an inner sealing ring 29 is fixedly connected to an inner wall of the outer sealing ring 28, an inner wall of the outer sealing sleeve 26 is fitted to an outer wall of the simulated wellbore 15, an outer wall of the inner sealing sleeve 27 is fitted to an inner wall of the simulated wellbore 15, two sets of the outer sealing sleeves 26 and the inner sealing sleeves 27 are correspondingly arranged at docking end portions of two adjacent sections of the simulated wellbores 15, a sealing gap is reserved between the outer sealing sleeve 26 and the inner sealing sleeve 27, and two sides of the outer sealing ring 28 are embedded and clamped in the sealing gap. A first hollow cavity 30 is formed in the outer sealing ring 28, a second hollow cavity 31 conforming to a contour of the first hollow cavity 30 is formed in the inner sealing ring 29, and an outer wall of the inner sealing ring 29 is fitted to an inner wall of the inner sealing sleeve 27. A pressing plate 32 is mounted on an outer side of the outer sealing sleeve 26, a third adjusting knob 33 penetrates through the pressing plate 32, the third adjusting knob 33 sequentially penetrates through the pressing plate 32, the outer sealing sleeve 26, the inner sealing sleeve 27, and the outer sealing ring 28 to achieve overall compression and fixation.

As described above, during a splicing assembly process of the simulated wellbores 15, the bottom pipe frame 20 and the top pipe frame 21 can not only provide supporting and positioning functions for the simulated wellbores 15, but also ensure overall stability of a splicing structure of the simulated wellbores 15. Meanwhile, the outer sealing sleeves 26, the inner sealing sleeves 27, and the outer sealing ring 28 are correspondingly arranged at a splicing docking position between two adjacent simulated wellbores 15, such that overall sealing performance after splicing assembly of the simulated wellbores 15 can be effectively improved. Specifically, two sides of the outer sealing ring 28 are correspondingly assembled with the outer sealing sleeves 26 and the inner sealing sleeves 27, the outer sealing sleeves 26 are fittingly sleeved on outer walls of the simulated wellbores 15, and the inner sealing sleeves 27 are fittingly arranged on inner walls of the simulated wellbores 15, such that wrapping positioning and fixation can be formed at docking end portions of the simulated wellbores 15. Since sealing gaps are reserved between the outer sealing sleeves 26 and the inner sealing sleeves 27, and two sides of the outer sealing ring 28 are respectively embedded and clamped in the sealing gaps formed by two sets of the outer sealing sleeves 26 and the inner sealing sleeves 27, docking positioning and connection fixation between two adjacent sections of the simulated wellbores 15 can be achieved.

Further, since the third adjusting knob 33 sequentially penetrates through the pressing plate 32, the outer sealing sleeve 26, the inner sealing sleeve 27, and the outer sealing ring 28, overall compression and fixation can be achieved. Therefore, after the third adjusting knob 33 is tightened by experimental personnel, synchronous compression and positioning limitation of the outer sealing sleeves 26 and the inner sealing sleeves 27 on two sides of the outer sealing ring 28 can be achieved through the clamping force of the pressing plate 32. During a compression process, the stability of a splicing structure between two adjacent simulated wellbores 15 can be effectively ensured. Meanwhile, the outer sealing sleeves 26 and the inner sealing sleeves 27 after compression compress the first hollow cavity 30 arranged in the outer sealing ring 28, and the outer sealing ring 28 is subjected to slight deformation during a force compression process of the first hollow cavity 30, thereby further fitting splicing gaps, significantly improving a sealing effect at docking positions of adjacent simulated wellbores 15, and ensuring overall sealing performance after completion of splicing of the simulated wellbores 15.

Furthermore, a second hollow cavity 31 conforming to a contour of the first hollow cavity 30 is formed in the inner sealing ring 29, and an outer wall of the inner sealing ring 29 is tightly fitted to an inner wall of the inner sealing sleeve 27. Therefore, after the third adjusting knob 33 is tightened by experimental personnel, the inner sealing sleeves 27 on two sides of the outer sealing ring 28 compress the inner sealing ring 29 under pressure, such that the second hollow cavity 31 in the inner sealing ring 29 is subjected to slight deformation. The deformed second hollow cavity 31 can sufficiently fill assembly gaps between the outer sealing ring 28 and the inner sealing sleeves 27, eliminate hidden dangers of splicing gaps, and further strengthen sealing performance after splicing assembly of the simulated wellbores 15.

Through arrangement of the above structures in cooperation with supporting, positioning, locking, and fixing effects of the bottom pipe frame 20 and the top pipe frame 21 on the simulated wellbores 15, the experimental device can not only achieve flexible and arbitrary splicing and combination of simulated wellbores 15 having a plurality of specifications and types, but also has advantages of convenient and efficient splicing operation, high splicing structural strength, and excellent assembly sealing performance. Therefore, the requirements of simulated drilling experimental tests under a plurality of operating conditions can be satisfied, the experimental errors caused by splicing loosening and sealing failure can be effectively avoided, and the accuracy and reliability of experimental data can be greatly improved.

A working principle of the technical solution provided by the present application is as follows:

During use, experimental personnel move the moving platform 3 to a top position of the rock sample loading cylinder 11, and start the driving mechanism 13 to drive and adjust a deflection angle of the rock sample loading cylinder 11, such that the transition wellbore 12 is accurately aligned with the drilling rig connecting member 8. Meanwhile, experimental personnel start the first hydraulic telescopic rod 6 to drive and adjust a relative included angle between the drilling rig connecting member 8 and the moving platform 3, such that the drilling rig connecting member 8 and the transition wellbore 12 maintain coaxial alignment. Subsequently, experimental personnel lock and fix the drilling rig connecting member 8 and the transition wellbore 12. In this way, the assembly stability between the drilling rig connecting member 8 and the transition wellbore 12 is further improved through clamping and positioning limitation functions of the pneumatic clamp 9. After completion of assembly, experimental personnel can perform a drilling simulation experiment on a rock sample loaded in the rock sample loading cylinder 11.

Experimental personnel can selectively splice and assemble different types of simulated wellbores 15 according to actual experimental operating condition requirements. During a wellbore splicing process, the simulated wellbores 15 are subjected to supporting positioning and locking fixation through the bottom pipe frame 20 and the top pipe frame 21. Meanwhile, multi-layer sealing treatment is performed on splicing gaps between adjacent simulated wellbores 15 through cooperation among the outer sealing sleeves 26, the inner sealing sleeves 27, and the outer sealing ring 28, thereby effectively improving structural stability and overall sealing performance after splicing of a plurality of sections of simulated wellbores 15. After completion of overall splicing assembly of the simulated wellbores 15, experimental personnel move the moving platform 3 to an end portion position of the simulated wellbores 15. In this way, the precise assembly docking between the drilling rig connecting member 8 and the simulated wellbores 15 is achieved through adjustment of a working height and an inclination angle of the drilling rig connecting member 8. Thereafter, drill-completion simulation experiments for different wellbore trajectories can be performed according to an overall splicing contour of the simulated wellbores 15, such that multi-operating-condition and multi-scenario experimental simulation can be achieved, thereby greatly expanding an experimental adaptation range of the device.

The present application covers any substitution, modification, equivalent method, and solution made within the spirit and scope of the present application. To provide the public with a thorough understanding of the present application, specific details are described in detail in the following preferred embodiments of the present application. However, those skilled in the art can fully understand the present application without descriptions of such details. In addition, to avoid unnecessary obscuring of the substance of the present application, well-known methods, processes, procedures, elements, circuits, and the like are not described in detail.

The above descriptions are only preferred implementations of the present application. It should be noted that, for those of ordinary skill in the art, several improvements and modifications may further be made without departing from principles of the present application, and such improvements and modifications shall also fall within the protection scope of the present application.

What is claimed is:

1. An intelligent system for drill-completion simulation experiments, comprising a base, wherein a gantry frame is slidably connected to a top portion of the base, a movable drilling rig system is slidably connected to the top portion of the base, a rock sample loading system and a placing rack are fixedly connected in the base, a simulated wellbore is arranged on the placing rack, and the simulated wellbore is formed by a combination of a straight wellbore structure and a deviated wellbore structure;
the movable drilling rig system comprises a moving platform and a support frame, the support frame is rotatably connected to a top portion of the moving platform, and a drilling rig connecting member is mounted on the support frame;
the rock sample loading system comprises a mounting frame and a rock sample loading cylinder, and the rock sample loading cylinder is rotatably connected to a top portion of the mounting frame; and
further comprising a variable wellbore arrangement system, wherein the variable wellbore arrangement system is configured for arbitrary splicing and combination of multi-specification simulated wellbores, and the variable wellbore arrangement system is connected to each of the base and the simulated wellbore.

2. The intelligent system for drill-completion simulation experiments according to claim 1, wherein a fixed base plate is fixedly connected to the top portion of the moving platform, the fixed base plate is rotatably hinged to two sides of a bottom of the support frame, a first hydraulic telescopic rod is rotatably connected to the top portion of the moving platform, one end of the first hydraulic telescopic rod away from the moving platform is rotatably hinged to the support frame, two second hydraulic telescopic rods are symmetrically arranged on the support frame, a telescopic end of the second hydraulic telescopic rod is fixedly connected to the drilling rig connecting member, a pneumatic clamp is fixedly connected to the top portion of the moving platform, and the pneumatic clamp is in corresponding cooperation with the drilling rig connecting member.

3. The intelligent system for drill-completion simulation experiments according to claim 1, wherein a driving mechanism is fixedly connected to the top portion of the mounting frame, the driving mechanism is configured to drive the rock sample loading cylinder to rotate at the top portion of the mounting frame, and a transition wellbore is fixedly connected to a top portion of the rock sample loading cylinder.

4. The intelligent system for drill-completion simulation experiments according to claim 1, wherein the variable wellbore arrangement system comprises a guide rail fixedly connected in the base, a bottom pipe frame is fixedly connected to a top portion of the guide rail, a top pipe frame is correspondingly arranged at a top portion of the bottom pipe frame, and the simulated wellbore is detachably inserted and clamped between the bottom pipe frame and the top pipe frame; and
the variable wellbore arrangement system further comprises an outer sealing sleeve sleeved at an end portion of the simulated wellbore, an inner sealing sleeve is fixedly connected to a side of the outer sealing sleeve away from the simulated wellbore, an outer sealing ring is fixedly connected between the outer sealing sleeve and the inner sealing sleeve, and an inner sealing ring is fixedly connected to an inner wall of the outer sealing ring.

5. The intelligent system for drill-completion simulation experiments according to claim 4, wherein a fixing frame is fixedly connected to one side of the guide rail, two side baffles are symmetrically arranged at the top portion of the guide rail, a spacing between the two side baffles is adapted to a bottom width of the bottom pipe frame for positioning limitation, an installation groove is formed in a middle portion of the guide rail, and the bottom pipe frame is locked and fixed in the installation groove through bolts and nuts.

6. The intelligent system for drill-completion simulation experiments according to claim 4, wherein adjusting sleeves are fixedly connected to two sides of the bottom pipe frame and a top portion of the top pipe frame, a clamping plate is slidably connected in the adjusting sleeve, a first adjusting knob is in threaded connection with an end portion of the adjusting sleeve, a second adjusting knob is slidably connected to an outer side wall of the adjusting sleeve, the second adjusting knob is in threaded connection with the clamping plate, a relief sliding slot is formed in the adjusting sleeve and configured to allow sliding and positioning limitation of the second adjusting knob, and the bottom pipe frame and the top pipe frame are locked and fixed through bolts and nuts.

7. The intelligent system for drill-completion simulation experiments according to claim 4, wherein an inner wall of the outer sealing sleeve is fitted to an outer wall of the simulated wellbore, and an outer wall of the inner sealing sleeve is fitted to an inner wall of the simulated wellbore.

8. The intelligent system for drill-completion simulation experiments according to claim 4, wherein two sets of the outer sealing sleeve and the inner sealing sleeve are respectively configured at docking end portions of two adjacent sections of the simulated wellbore, a sealing gap is reserved between the outer sealing sleeve and the inner sealing sleeve, and two sides of the outer sealing ring are embedded and clamped in the sealing gap.

9. The intelligent system for drill-completion simulation experiments according to claim 4, wherein a first hollow cavity is formed in the outer sealing ring, a second hollow cavity conforming to an contour of the first hollow cavity is formed in the inner sealing ring, and an outer wall of the inner sealing ring is fitted to an inner wall of the inner sealing sleeve.

10. The intelligent system for drill-completion simulation experiments according to claim 4, wherein a pressing plate is installed on an outer side of the outer sealing sleeve, a third adjusting knob penetrates through the pressing plate, and the third adjusting knob sequentially penetrates through the pressing plate, the outer sealing sleeve, the inner sealing sleeve, and the outer sealing ring to achieve overall compression and fixation.
